(19) United States
(12) Patent Application Publication
(10) Pub. No.: US 2018/0035715 A1
(43) Pub. Date: Feb. 8, 2018

(54) Multi-functional and temperature controlling intelligent electronic cigarette

(71) Applicant: Jin Ya WU, AnHui Province (CN)

(72) Inventor: Jin Ya WU, AnHui Province (CN)

(21) Appl. No.: 15/231,763

(22) Filed: Aug. 8, 2016

(51) Int. Cl. A24F 47/00; F16L 15/00; H05B 1/02

(52) U.S. Cl. CPC A24F 47/008; H05B 1/0297; F16L 15/00

(57) ABSTRACT

A multi-functional temperature controlling intelligent electronic cigarette, having a main body, a tobacco toasting atomizer, a PCB, and a threaded port and two annular metal gaskets having different radii at an upper end of the main body; the two gaskets are connected to output ends of a positive pole and a negative pole of the PCB respectively; a tobacco toasting container is provided inside the atomizer; a heat sensitive resistor is connected onto the container; the atomizer is provided with a threaded connector whose two outer sides are each provided with a spring loaded pin; the two pins are different in their distances from the threaded connector; the two spring loaded pins are connected to a positive pole and a negative pole of the heat sensitive resistor respectively; when the main body is connected to the atomizer, the two pins are connected with the two gaskets respectively.

### BACKGROUND OF THE INVENTION

The present invention belongs to the technical field of electronic cigarette, and more specifically relates to a multi-functional and temperature controlling intelligent electronic cigarette.

Tobacco toasting equipment now available in the market has the following disadvantages: 1. A tobacco toasting container of a tobacco toasting equipment now available in the market is installed inside a main body disposed with a PCB and a battery; high-temperature toasting over time will adversely affect the service lives of the components on the PCB and increase the risk concerning battery safety; 2. The tobacco toasting container is integral with the main body; its use over time will cause residues to accumulate inside or it may be damaged, but it is impossible to clean up the residues or replace it in case of damage, thereby shortening the service life of the entire equipment; 3. The existing tobacco toasting equipment cannot achieve real-time monitoring of the temperature of the tobacco toasting container, and also cannot achieve variation of tastes through precise adjustment of heating speed; 4. The existing tobacco toasting equipment can only serve a single function of toasting tobacco, thereby being very limited in terms of diversified uses.

### BRIEF SUMMARY OF THE INVENTION

In view of the aforesaid disadvantages now present in the prior art, the present invention provides a multi-functional temperature controlling intelligent electronic cigarette. The electronic cigarette provided by the present invention has the e-cigarette main body separable from the tobacco toasting atomizer. Such a structure can prevent the tobacco toasting container from affecting the service lives of the components on the PCB; also, the influence over the battery is avoided and residues inside the tobacco toasting container can be cleaned up easily.

The present invention adopts the following technical scheme: A multi-functional temperature controlling intelligent electronic cigarette, comprising an e-cigarette main body and a tobacco toasting atomizer; a PCB panel is provided inside the e-cigarette main body; a threaded port and two annular metal gaskets surrounding the threaded port are provided at an upper end of the e-cigarette main body; the two annular metal gaskets are different in their radii; the two annular metal gaskets are connected to an output end of a positive pole of the PCB panel and an output end of a negative pole of the PCB panel respectively; a tobacco toasting container is provided inside the tobacco toasting atomizer; a heat sensitive resistor is connected onto the tobacco toasting container; a lower end of the tobacco toasting atomizer is provided with a threaded connector; the tobacco toasting atomizer is connected to the threaded port on the e-cigarette main body via the threaded connector; two outer sides of the treaded connector are each provided with a spring loaded pin; the two spring loaded pins are different in their distances from the threaded connector; inner portions of the two spring loaded pins are connected to a positive pole of the heat sensitive resistor and a negative pole of the heat sensitive resistor respectively; when the e-cigarette main body is connected to the tobacco toasting atomizer, the two spring loaded pins are connected with the two annular metal gaskets respectively.

Preferably, the threaded port is a general type having a 510 mm diameter.

Preferably, a side surface of the e-cigarette main body is provided with a slider switch.

Preferably, the side surface of the e-cigarette main body is provided with a start button.

Preferably, the side surface of the e-cigarette main body is provided with a display screen.

Preferably, the display screen is OLED display screen.

Preferably, the side surface of the e-cigarette main body is provided with temperature adjustment buttons.

Preferably, the spring loaded pin nearer to the threaded connector is connected to the positive pole of the heat sensitive resistor; the spring loaded pin more distal from the threaded connector is connected to the negative pole of the heat sensitive resistor.

Preferably, the annular metal gasket having a smaller radius is connected to the output end of the positive pole of the PCB panel; the annular metal gasket having a larger radius is connected to the output end of the negative pole of the PCB panel.

Compared with the prior arts, the present invention has the following beneficial effects: According to the present invention, the e-cigarette main body is separable from the tobacco toasting atomizer. Such a structure renders a separable tobacco toasting container to constitute an individual and separated tobacco toasting atomizer. Therefore, even though the tobacco toasting container is used for high temperature toasting over time, it will not adversely affect the battery in the main body and the components on the PCB, thereby lengthening their service lives and eliminating safety risks. Such a separable structure enables easy cleaning of residues and dirts left inside the tobacco toasting container during its use over a long period of time; when there is mechanical failure, a new tobacco toasting atomizer can be replaced instead of replacing the entire equipment, thereby lowering the costs. The present invention can serve the function of tobacco toasting and can also serve the function of being an electronic cigarette. When a tobacco toasting atomizer is attached, the present invention serves the function of tobacco toasting; when a e-liquid atomizer is instead attached to the threaded port of a general type having a diameter of 510 mm, the present invention serves the function of being an electronic cigarette. The temperature adjustment buttons are provided to vary the taste of tobacco according to personal taste by increasing or decreasing the power output for toasting. The display screen set on a side surface of the e-cigarette main body enables direct observation of temperature changes inside the tobacco toasting container. The slider switch enables switching between a temperature control mode and a power mode.

In summary, the present invention has a lengthened service life and a lowered safety risks. It also serves the function of tobacco toasting and also serves the function of being an e-cigarette. Further, it may adjust the power output for toasting to vary the taste of the tobacco.

### BRIEF DESCRIPTION OF THE DRAWINGS

FIG. 1 is a schematic diagram showing a structure of the present invention.

FIG. 2 shows the internal structures of the present invention shown in FIG. 1.

### REFERENCES IN THE FIGURES

1—e-cigarette main body; 2—tobacco toasting atomizer; 3—PCB panel; 4—threaded port; 5—annular metal gaskets; 6—heat sensitive resistor; 7—threaded connector; 8—spring loaded pin; 9—slider switch; 10—start button; 11—display screen; 12—temperature adjustment buttons; 13—tobacco toasting container

### DETAILED DESCRIPTION OF THE INVENTION

The present invention is described further in detail below with reference to an embodiment shown and represented in the accompanying drawings.

### Embodiment 1

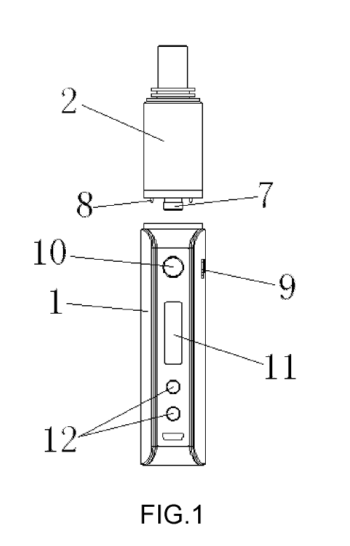

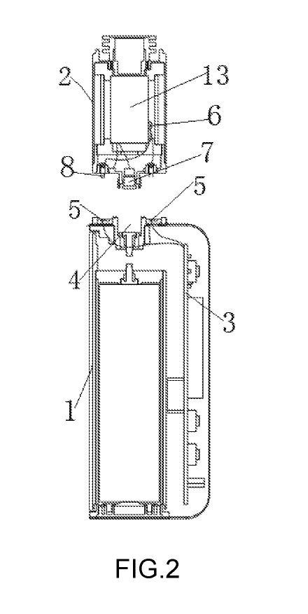

As shown in FIGS. 1 and 2, a multi-functional temperature controlling intelligent electronic cigarette comprises an e-cigarette main body 1 and a tobacco toasting atomizer 2; a PCB panel 3 is provided inside the e-cigarette main body 1; a threaded port 4 and two annular metal gaskets 5 surrounding the threaded port 4 are provided at an upper end of the e-cigarette main body 1; the threaded port 4 is a general type having a 510 mm diameter; the two annular metal gaskets 5 are different in their radii; the annular metal gasket having a smaller radius is connected to an output end of a positive pole of the PCB panel 3; the annular metal gasket having a larger radius is connected to an output end of a negative pole of the PCB panel 3.

A tobacco toasting container 13 is provided inside the tobacco toasting atomizer 2; a heat sensitive resistor 6 is connected onto the tobacco toasting container 13; a lower end of the tobacco toasting atomizer 2 is provided with a threaded connector 7; the tobacco toasting atomizer 2 is connected to the threaded port 4 on the e-cigarette main body 1 via the threaded connector 7; two outer sides of the treaded connector 7 are each provided with a spring loaded pin 8; the spring loaded pins are different in their distances from the threaded connector 7; the spring loaded pin nearer to the threaded connector 7 is connected to a positive pole of the heat sensitive resistor 6; the spring loaded pin more distal from the threaded connector 7 is connected to a negative pole of the heat sensitive resistor 6. When the e-cigarette main body 1 is connected to the tobacco toasting atomizer 2, the two spring loaded pins are connected with the two annular metal gaskets 5 respectively. A slider switch 9, a start button 10, an OLED display screen 11 and temperature adjustment buttons 12 are provided on a side surface of the e-cigarette main body 1.

The embodiment described above is only an illustrative example of the present invention. A person skilled in this field of art may make various changes or modifications to or may use equivalent alternatives in the above described embodiment without deviating from the essence of the present invention or exceeding the scope defined by the claims.

What is claimed is:

1. A multi-functional temperature controlling intelligent electronic cigarette, comprising an e-cigarette main body (1) and a tobacco toasting atomizer (2); a PCB panel (3) is provided inside the e-cigarette main body; a threaded port (4) and two annular metal gaskets (5) surrounding the threaded port are provided at an upper end of the e-cigarette main body; the two annular metal gaskets are different in their radii; the two annular metal gaskets are connected to an output end of a positive pole of the PCB panel and an output end of a negative pole of the PCB panel respectively; a tobacco toasting container (13) is provided inside the tobacco toasting atomizer; a heat sensitive resistor (6) is connected onto the tobacco toasting container; a lower end of the tobacco toasting atomizer is provided with a threaded connector (7); the tobacco toasting atomizer is connected to the threaded port on the e-cigarette main body via the threaded connector; two outer sides of the treaded connector are each provided with a spring loaded pin (8); the two spring loaded pins are different in their distances from the threaded connector; inner portions of the two spring loaded pins are connected to a positive pole of the heat sensitive resistor and a negative pole of the heat sensitive resistor respectively; when the e-cigarette main body is connected to the tobacco toasting atomizer, the two spring loaded pins are connected with the two annular metal gaskets respectively.

2. The multi-functional temperature controlling intelligent electronic cigarette as in claim 1, wherein the threaded port is a general type having a 510 mm diameter.

3. The multi-functional temperature controlling intelligent electronic cigarette as in claim 1, wherein a side surface of the e-cigarette main body is provided with a slider switch (9).

4. The multi-functional temperature controlling intelligent electronic cigarette as in claim 1, wherein a side surface of the e-cigarette main body is provided with a start button (10).

5. The multi-functional temperature controlling intelligent electronic cigarette as in claim 1, wherein a side surface of the e-cigarette main body is provided with a display screen (11).

6. The multi-functional temperature controlling intelligent electronic cigarette as in claim 5, wherein the display screen is OLED display screen.

7. The multi-functional temperature controlling intelligent electronic cigarette as in claim 1, wherein a side surface of the e-cigarette main body is provided with temperature adjustment buttons (12).

8. The multi-functional temperature controlling intelligent electronic cigarette as in claim 1, wherein the spring loaded pin nearer to the threaded connector is connected to the positive pole of the heat sensitive resistor; the spring loaded pin more distal from the threaded connector is connected to the negative pole of the heat sensitive resistor.

9. The multi-functional temperature controlling intelligent electronic cigarette as in claim 8, wherein the annular metal gasket having a smaller radius is connected to the output end of the positive pole of the PCB panel; the annular metal gasket having a larger radius is connected to the output end of the negative pole of the PCB panel.
